(19) United States
(12) Patent Application Publication
(10) Pub. No.: US 2008/0090464 A1
(43) Pub. Date: Apr. 17, 2008

(54) Mount adaptor

(75) Inventor: Elliot Azoulay, Brooklyn, NY (US)

Correspondence Address: AMSTER, ROTHSTEIN & EBENSTEIN LLP, 90 PARK AVENUE, NEW YORK, NY, 10016, US

(73) Assignee: ESI Cases & Accessories, Inc.

(21) Appl. No.: 11/545,613

(22) Filed: Oct. 11, 2006

(51) Int. Cl. H01R 24/04

(52) U.S. Cl. 439/668

(57) ABSTRACT

A mount adaptor including an adaptor portion having an input power receiver plug, a stem having a distal end attached to the adaptor portion and a proximal end, a mount attached to the proximal end of the stem for mounting an electronic device, and a flexible conductive wire electrically connected to the adaptor portion that delivers electrical power from the adaptor portion to the electronic device.

### TECHNICAL FIELD

The present invention is generally related to electrical adapters for use with small electrical and electronic devices.

### BACKGROUND

When traveling in a vehicle, people often wish to enjoy the use of an entertainment-oriented electronic device, such as, for example, a video game system, a television, or a radio, such as a satellite radio. Particularly in the case of electronic devices, such as satellite radios, that do not have their own internal battery supply, it is necessary to provide a means for electrically connecting the electronic device to the power supply of the vehicle, most commonly through the vehicle cigarette lighter, in order to power the electronic device. However, not all electronic devices require the same level of power input and/or do not share a common power input connection configuration, so that multiple adaptors or other connection means are required to connect a variety of electronic devices to the vehicle cigarette lighter. Thus, people must either store multiple adaptors in their vehicle to accommodate the variety of electronic devices, or remember to retrieve the adaptors before entering the vehicle. For example, satellite radios require either 5V, 6V or 12V for power input depending on the manufacturer and model type. Further, the fact that not all satellite radios share a common mounting configuration adds to the difficulty of providing a common connection means for a variety of satellite radios.

Accordingly, there is a need for an electrical adapter that is versatile enough to provide power to more than one electronic device, and in particular to more than one brand and model of satellite radio, so that the store need not stock multiple adaptors and the user, having more than one device, need not transport multiple adaptors. Further, such electrical adapters should be capable of being used as a charger when the device has an internal battery. Still further, some satellite radios incorporate a rechargeable internal battery.

### SUMMARY OF THE INVENTION

A mount adaptor according to an exemplary embodiment of the present invention includes an adaptor portion including an input power receiver plug, a stem having a distal end attached to the adaptor portion and a proximal end, a mount attached to the proximal end of the stem for mounting an electronic device, and a flexible conductive wire electrically connected to the adaptor portion that delivers electrical power from the adaptor portion to the electronic device.

In at least one embodiment, the input power receiver plug is a vehicle cigarette lighter connector for electrically connecting the holder adaptor to a vehicle cigarette lighter.

In at least one embodiment, the electronic device is a satellite radio.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 shows a mount adaptor according to an exemplary embodiment of the present invention;

FIG. 2 is a cross-sectional view of the connector portion of the mount adaptor of FIG. 1 taken along the line 2-2;

FIG. 3 is a top plan view of the mount of the mount adaptor of FIG. 1;

FIG. 4 is a cross-sectional view of the mount taken along the line 4-4 in FIG. 3; and

FIG. 5 is a simplified block diagram of the adaptor portion of the mount adaptor of FIG. 1.

### DETAILED DESCRIPTION OF PREFERRED EMBODIMENTS

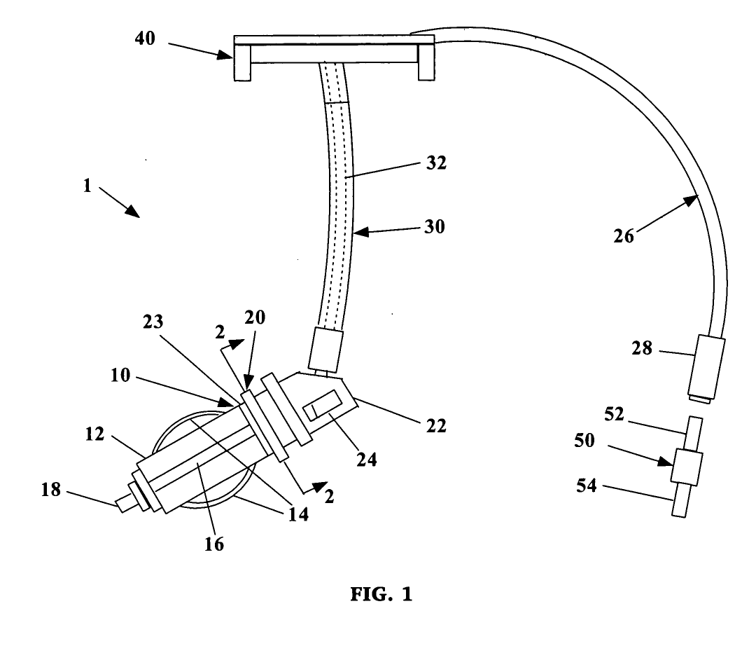

FIG. 1 shows a mount adaptor, generally designated by reference number 1, according to an exemplary embodiment of the present invention. The mount adaptor 1 includes an adaptor portion, generally designated by reference number 10, a stem, generally designated by reference number 30, a mount, generally designated by reference number 40, connected to the adaptor portion 10 by the stem 30, and a flexible electrically conductive wire, generally designated by reference number 26, extending from the adaptor portion 10 and through the stem 30 and mount 40. As explained in further detail below, the adaptor portion 10 is configured for electrical connection to a vehicle cigarette lighter, so that an electronic device, such as, for example, a satellite radio, can be mounted on the mount 40 and powered or recharged through the flexible wire 26.

A base portion 22 is disposed at a proximal end portion of the adaptor portion 10 and a barrel-shaped cigarette lighter connector portion 12 is disposed at a distal end portion of the adaptor portion 10. The cigarette lighter connector portion 12 includes side terminals 14, 16 and an end terminal 18. As is known in the art, the side terminals 14, 16 and end terminals 18 make electrical contact with a vehicle cigarette lighter socket upon insertion of the connector portion 12 into the socket. Side terminals 14 may extend outwardly from the main body of the connector portion 12, while side terminals 16 may lay flush along the main body.

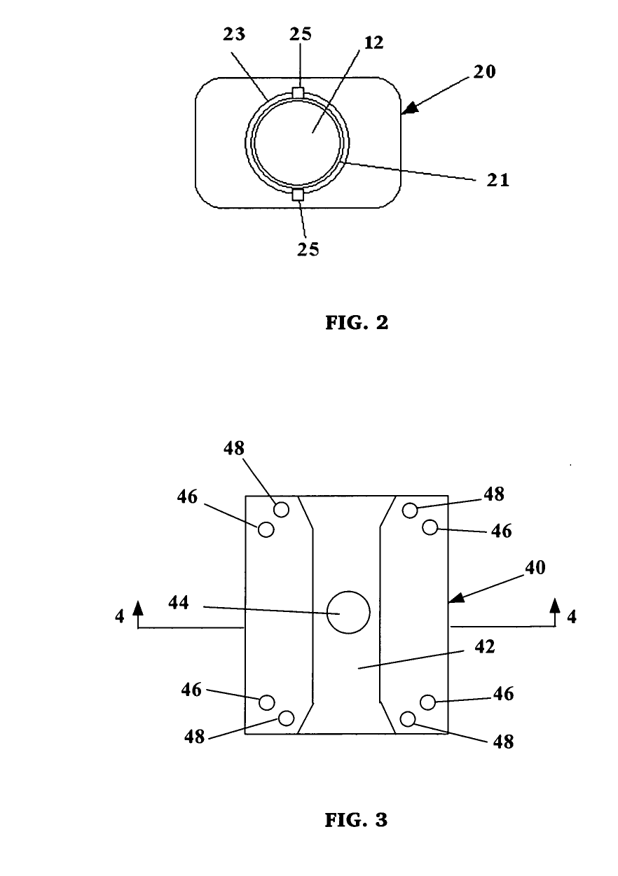

A locking collar, generally designated by reference number 20, is disposed around and in sliding relation with the connector portion 12. As shown in FIG. 2, which is a cross-sectional view of the connector portion 12 taken along the line 2-2 in FIG. 1, the locking collar 20 includes a circular opening 21 through which the connector portion 12 extends. A flange 23 extends around the opening 21 in the locking collar 20. The flange 23 includes outwardly extending portions 25 that have profiles which match that of the side terminals 14. After the connector portion 12 is inserted into a vehicle cigarette lighter socket, the locking collar 20 can be slid forward until the outwardly extending portions 25 of the flange 23 engage with the side terminals 14, at which point the locking collar 20 engages with the outer profile of the socket to prevent the entire holder adaptor 1 from rotating about the longitudinal axis of the adaptor portion 10.

The stem 30 extends from the proximal end of the adaptor portion 10. The stem 30 is preferably constructed so as to be flexible, and may be made of any suitable material, such as, for example, polypropylene, metal or plastic. The stem 30 includes a central bore 32 through which the flexible wire 26 extends. The mount 40 is preferably rigidly connected to the stem 30 so that the mount 40 follows the angle at which the stem 30 is adjusted. The flexibility of the stem 30 allows a user to adjust the angle at which the electronic device mounted on the mount 40 is facing when the mount adaptor 1 is inserted into a vehicle cigarette lighter.

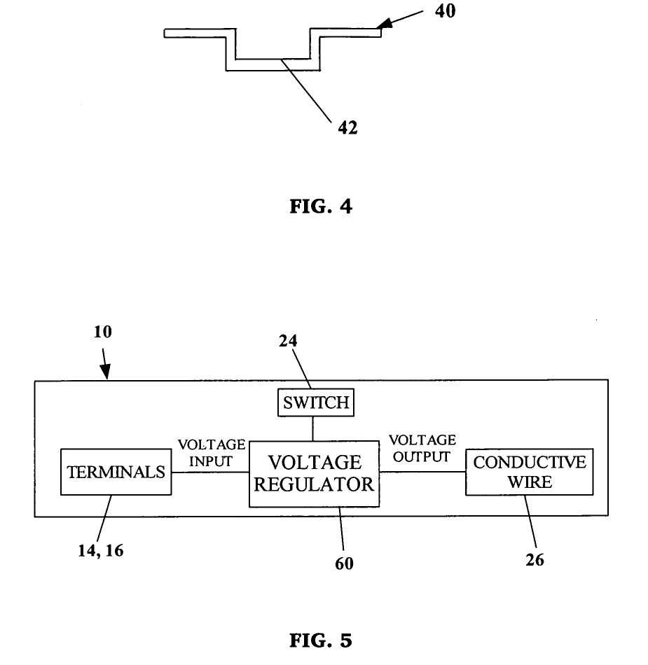

FIG. 3 is a top plan view of the mount 40 and FIG. 4 is a cross-sectional view of the mount 40 taken along the line 4-4 in FIG. 3. As shown in FIG. 3, a groove 42 extends along the center axis of the mount 40. An opening 44 in communication with the bore 32 is formed at the center of the groove 42. The flexible wire 26 extends from the bore 32, through the opening 44 and into the groove 42. The groove 42 provides clearance for the flexible wire 26 to pass underneath an electronic device mounted on the mount 40, thus allowing the flexible wire 26 to be placed into position to be electrically connected to the electronic device. The mount 40 also includes a first set of mounting holes 46 and a second set of mounting holes 48. The two sets of mounting holes 46, 48 are offset from each other to accommodate mounting of various electronic devices. Preferably, each set of mounting holes 46, 48 corresponds to one of two types of standardized mounting bolt patterns of satellite radios or other electronic devices.

The flexible wire 26 terminates at a jack 28 that is preferably sized to receive any one of a series of adaptor plugs, such as the adaptor plug 50 shown in FIG. 1. The adaptor plug 50 includes a first plug 52 that is sized for insertion into the jack 28, and a second plug 54 for insertion into the power input of an electronic device. Each adaptor plug in the series may include a different sized second plug, so that an adaptor plug may be replaced with another adaptor plug depending on the particular application. For example, the size of the second plug may be keyed to the voltage required for powering the electronic device.

The base portion 22 of the adaptor portion 10 preferably includes a switch 24 which allows a user to adjust the voltage output of the mount adaptor 1 when the mount adaptor 1 is plugged into a vehicle cigarette lighter. In this regard, as shown in FIG. 5, which shows a simplified block diagram of the adaptor portion 10, the switch 24 may be operatively associated with a voltage regulator means 60. The voltage regulator means 60 may be, for example, a conventional voltage regulator board, resistors or other suitable component for reducing the voltage output of the vehicle cigarette lighter to a voltage required by the electronic device. Preferably, the voltage regulator means 60 allows for adjustment of 12 V input voltage to 5 V, 6V or full 12 V output, as needed. The regulator means 60 may also include circuitry specifically adapted to make the adapter act as a battery charger when the electronic device mounted to the adapter has an internal rechargeable battery.

Now that the preferred embodiments have been shown and described in detail, various modifications and improvements thereon will be readily apparent to those skilled in the art. Accordingly, the spirit and scope of the present invention is to be construed broadly and be limited only by the appended claims, and not by the foregoing specification.

What is claimed is:

1. A mount adaptor comprising:
an adaptor portion including an input power receiver plug;
a stem having a distal end attached to the adaptor portion and a proximal end;
a mount attached to the proximal end of the stem for mounting an electronic device; and
a flexible conductive wire electrically connected to the adaptor portion that delivers electrical power from the adaptor portion to the electronic device.

2. The mount adaptor of claim 1, wherein the input power receiver plug is a vehicle cigarette lighter connector for electrically connecting the holder adaptor to a vehicle cigarette lighter.

3. The mount adaptor of claim 1, wherein the adaptor portion comprises a switch operatively associated with voltage regulator means for adjusting the voltage passed through the flexible conductive wire from the adaptor portion.

4. The mount adaptor of claim 1, wherein the vehicle cigarette lighter connector includes side terminals, and the adaptor portion further includes a locking collar slidably mounted on the cigarette lighter connector that engages the side terminals to prevent the holder adaptor from rotating about a longitudinal axis of the cigarette lighter connector when the cigarette lighter connector is plugged into a vehicle cigarette lighter.

5. The mount adaptor of claim 1, wherein the stem is flexible.

6. The mount adaptor of claim 1, wherein the stem comprises a central bore, and the flexible conductive wire passes through the central bore.

7. The mount adaptor of claim 6, wherein the mount comprises an opening in communication with the bore, and the flexible conductive wire extends through the opening.

8. The mount adaptor of claim 7, wherein the mount further comprises a groove extending along a central axis of the mount and in communication with the opening, the groove guiding the flexible conductive wire underneath an electronic device attached to the mount.

9. The mount adaptor of claim 1, wherein the mount comprises at least two sets of mounting holes, each one of the at least two sets of mounting holes corresponding to one of at least two electronic device mounting configurations

10. The mount adaptor of claim 1, wherein the flexible wire terminates in a jack for connection to one of a plurality of different sized adaptor plugs.

11. The mount adaptor of claim 1, wherein the electronic device is a satellite radio.

12. The mount adaptor of claim 1, wherein the electrical power delivered by the adaptor portion is used to recharge an internal battery in the electronic device.
